(19) United States
(12) Patent Application Publication
(10) Pub. No.: US 2011/0113088 A1
(43) Pub. Date: May 12, 2011

(54) METHOD AND APPARATUS FOR PROVIDING REMOTE USER INTERFACE SERVICE

(75) Inventors: Ju-hee SEO, Hwaseong-si (KR); Young-chul SOHN, Seoul (KR); Jong-baek KIM, Suwon-si (KR)

(73) Assignee: SAMSUNG ELECTRONICS CO., LTD., Suwon-si (KR)

(21) Appl. No.: 12/770,049

(22) Filed: Apr. 29, 2010

(30) Foreign Application Priority Data
Nov. 12, 2009 (KR) 10-2009-0109188

(51) Int. Cl. G06F 15/16

(52) U.S. Cl. 709/203

(57) ABSTRACT

A method and an apparatus for providing a remote user interface (UI) service are provided. The method includes receiving an event message including a uniform resource locator (URL) for accessing a UI resource from a remote UI server device; obtaining the UI resource from the remote UI server device using the URL; receiving text input for controlling the remote UI server device using the UI resource; and transmitting the text to the remote UI server device.

### CROSS-REFERENCE TO RELATED PATENT APPLICATION

This application claims priority from Korean Patent Application No. 10-2009-109188, filed on Nov. 12, 2009, in the Korean Intellectual Property Office, the disclosure of which is incorporated by reference herein in its entirety.

### BACKGROUND

1. Field

Exemplary embodiments relate to a method and an apparatus for providing a remote user interface (UI) service, and more particularly, to a method and an apparatus for providing a remote UI service such that text may be input to a device via a network.

2. Description of the Related Art

A television (TV) is located at a fixed location, such as a living room, and reproduces broadcasts, such as air-wave broadcasts and cable broadcasts, and video data stored in a storage medium, such as digital versatile disc (DVD) or a Blu-ray disc (BD), etc. In such cases, the main purpose of a TV is video reproduction, and thus a TV may be controlled by using a simple control device, such as a remote controller. In other words, when a TV is not multi-functional, a user may perform simple operations for controlling the TV, such as channel selection and volume control, by using a simple control device, such as a remote controller.

However, more and more functions are being included in a TV, and due to recent developments of home networks, various devices may be connected to a TV. Therefore, user convenience is now limited to a user interface (UI) method for controlling various functions of a TV by using a simple control device, such as a remote controller.

### SUMMARY

Exemplary embodiments are directed to a method and an apparatus for providing a remote UI service in such a way that a text input requesting device, such as a multi-functional television (TV), receives text from a text inputting device capable of easily inputting text via a network and is controlled by the text inputting device by executing a control function corresponding to the text.

Exemplary embodiments are directed to a computer readable recording medium having recorded thereon a computer program for executing the method.

According to exemplary embodiments, there is provided a method of providing a remote user interface (UI) service to a remote UI client device, the method including receiving an event message including a URL for accessing a UI resource from a remote UI server device; obtaining the UI resource from the remote UI server device by using the URL; receiving an external input of text for controlling the remote UI server device by using the UI resource; and transmitting the externally input text to the remote UI server device.

The UI resource may include a web page or bitmaps of an application and provide a UI for text input.

The web page may include either a text inputting module within itself or a module for activating a text inputting application existing within the remote UI client device.

The method further includes outputting the UI resource.

The outputting of the UI resource may include outputting the web page by using a web browser or outputting the bitmaps of the UI application by using a bitmap browser.

The method may further include obtaining capability information with respect to the UI resource from the remote UI server device, wherein the capability information includes resolution information and codec information with respect to the UI resource.

The method may further include transmitting capability information with respect to the UI resource that can be processed by the remote UI client device to a negotiating device; and obtaining the capability information negotiated between the remote UI server device and the remote UI client device from the negotiating device.

During the transmitting of the externally input text to the remote UI server device, the text may be transmitted in the unit of a consonant and a vowel, in the unit of a character, or in the unit of a sentence, and the text may be transmitted by using either the same session as a session for obtaining the UI resource or an asynchronous session independent from the session for obtaining the UI resource.

The event message may be provided according to universal plug and play (UPnP) RemoteUI or consumer electronics association (CEA) 2014 standards.

According to exemplary embodiments, there is provided a method of providing a remote user interface (UI) service to a remote UI server device, the method including externally selecting a UI resource for requesting an input of text for controlling the remote UI server device; transmitting an event message including a URL for accessing the UI resource to a remote UI client device; transmitting the UI resource to the remote UI client device in response to a request by the remote UI client device; receiving the text from the remote UI client device; and outputting the text.

The method may further include performing a control function related to the text.

The UI resource may include a web page or bitmaps of an application and provides a UI for text input.

The web page may include either a text inputting module within itself or a module for activating a text inputting application existing within the remote UI client device.

The method may further include transmitting capability information with respect to the UI resource to the remote UI client device, wherein the capability information includes resolution information and codec information with respect to the UI resource.

The method may further include transmitting the capability information with respect to the UI resource to a negotiating device; and obtaining the capability information negotiated between the remote UI server device and the remote UI client device from the negotiating device.

During the receiving of the externally input text from the remote UI client device, the text may be transmitted in the unit of a consonant and a vowel, in the unit of a character, or in the unit of a sentence, and the text may be received by using either the same session as a session for transmitting the UI resource or an asynchronous session independent from the session for transmitting the UI resource.

The event message may be provided according to UPnP RemoteUI or CEA 2014 standards.

According to exemplary embodiments, there is provided a remote user interface (UI) client device including an event handling unit that receives an event message including a URL for accessing a UI resource from a remote UI server device; a UI resource obtaining unit that obtains the UI resource from the remote UI server device by using the URL; a text inputting unit that receives an external input of text for controlling the remote UI server device by using the UI resource; and a text transmitting unit that transmits the externally input text to the remote UI server device.

According to exemplary embodiments, there is provided a remote user interface (UI) server device including a UI selecting unit that externally selects a UI resource for requesting an input of text for controlling the remote UI server device; an event handling unit that transmits an event message including a URL for accessing the UI resource to a remote UI client device; a UI resource transmitting unit that transmits the UI resource to the remote UI client device in response to a request by the remote UI client device; a text receiving unit that receives the text from the remote UI client device; and an outputting unit that outputs the text.

### BRIEF DESCRIPTION OF THE DRAWINGS

The above and other aspects will become more apparent by describing in detail exemplary embodiments thereof with reference to the attached drawings in which:

FIG. 1 is a diagram showing a method of providing a remote user interface (UI) service according to an exemplary embodiment;

FIG. 2 is a block diagram of a remote UI client device according to an exemplary embodiment of;

FIG. 3 is a block diagram of the remote UI server device according to an exemplary embodiment of;

FIG. 4 is a flowchart of providing a remote UI service by a remote UI client device according to an exemplary embodiment of; and

FIG. 5 is a flowchart of providing a remote UI service by a remote UI server device according to an exemplary embodiment of.

### DETAILED DESCRIPTION

Exemplary embodiments will now be described more fully with reference to the accompanying drawings, in which the exemplary embodiments of the invention are shown. In the drawings, the thicknesses of layers and regions may be exaggerated for clarity. Like reference numerals in the drawings denote like elements.

FIG. 1 is a diagram showing a method of providing a remote user interface (UI) service according to an exemplary embodiment.

A remote UI server device 120 may remotely provide a UI resource via a network. The UI resource may provide, for example, a user interface for text input and may include a web page or bitmaps of an application. A remote UI client device 110 may receive inputs of various control instructions and texts from a user via the UI resource provided by the remote UI server device 120, and may transmit the input information to the remote UI server device 120. The remote UI server device 120 performs control functions related to the corresponding UI resource by using the information transmitted from the remote UI client device 110.

The remote UI server device 120 may be a network-based device to which a user may not easily input various control instructions and texts, and may be any of various consumer electronics (CE), such as a TV or a set-top box.

The remote UI client device 110 may be a network-based device to which a user may easily input various control instructions and texts, and may be, for example, any mobile device with a keypad.

According to the present exemplary embodiment, there is provided a user convenience in that, even if it is not easy to input text to the remote UI server device 120 requiring inputs of text, various functions of the remote UI server device 120 may be easily controlled by inputting text via the remote UI client device 110, which may easily have text inputted thereto.

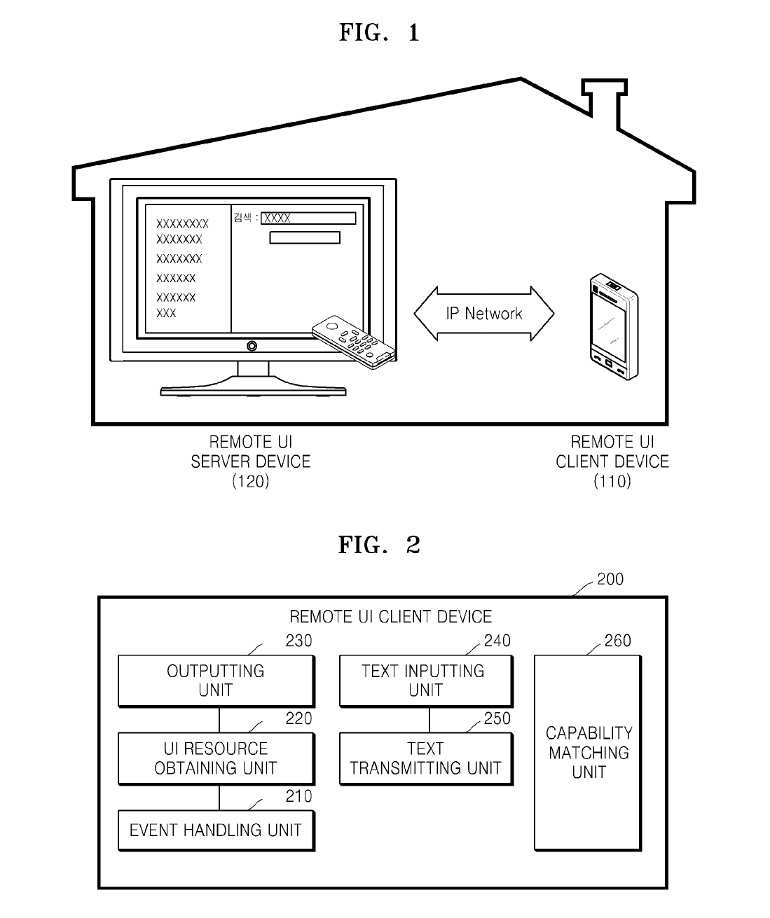

FIG. 2 is a block diagram of a remote UI client device 200 according to an exemplary embodiment.

The remote UI client device 200 includes an event handling unit 210, a UI resource obtaining unit 220, an outputting unit 230, a text inputting unit 240, a text transmitting unit 250, and a capability matching unit 260.

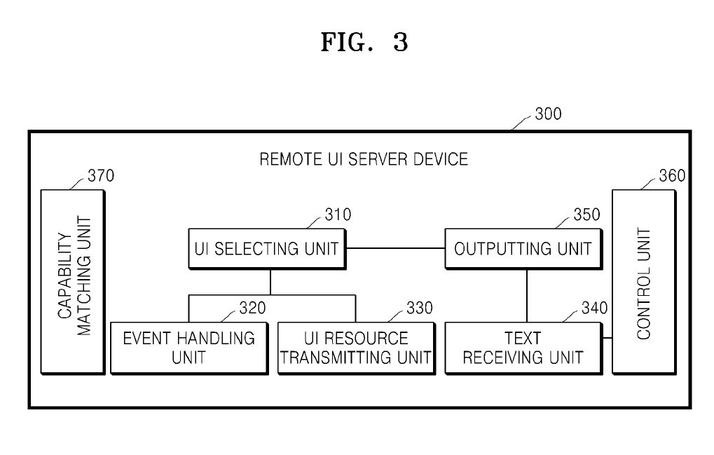

The event handling unit 210 receives an event message including a uniform resource locator (URL) from a remote UI server device 300, the URL for accessing a UI resource corresponding to a current state when a user input, such as a text input, is needed while a user is browsing menus in a remote UI server device 300 as shown in FIG. 3.

A UI resource provides, for example, a UI for text input, and includes a web page or bitmaps of an application. A web page includes either a text inputting module within itself or a module for activating a text inputting application existing within the remote UI client device 200. For example, when the remote UI client device 200 is a handheld phone (HHP), a web page may include a module for activating an instant message editor (IME) application existing within the HHP.

A module for activating a text inputting application may be embodied in such a way that, when a user locates a UI focus at a location within a web page, the text inputting application is activated. The location within the web page may be predetermined. Alternatively, the module for activating a text inputting application may be embodied according to any of various other methods.

An event message may be provided according to any of the various home network standards, including, for example, the universal plug and play (UPnP) RemoteUI or consumer electronics association (CEA) 2014 standards.

The UI resource obtaining unit 220 obtains a UI resource from the remote UI server device 300 by using a URL. Protocols via which the UI resource obtaining unit 220 may obtain a UI resource include, for example, extended remoting technology (XRT), remote desktop protocol (RDP), or hypertext transfer protocol (HTTP), etc. However, it will be apparent that other protocols may also be used.

The capability matching unit 260 obtains capability information with respect to a UI resource from the remote UI server device 300. Capability information includes resolution information and codec information with respect to a UI resource. The UI resource obtaining unit 220 may obtain a UI resource that can be processed by the remote UI client device 200 with reference to capability information obtained by the capability matching unit 260.

Meanwhile, if a device (e.g. a UPnP control point device) acting as a negotiator between the remote UI server device 300 and the remote UI client device 200 exists, the capability matching unit 260 transmits to the negotiating device capability information with respect to a UI resource that can be processed by the remote UI client device 200. For example, the capability matching unit 260 obtains capability information negotiated between the remote UI server device 300 and the remote UI client device 200 from the negotiating device. The UI resource obtaining unit 220 may obtain a UI resource that can be processed by the remote UI client device 200 with reference to the negotiated capability information obtained by the capability matching unit 260.

The outputting unit 230 outputs a UI resource. The outputting unit 230 either outputs a web page by using a web browser or bitmaps of a UI application by using a bitmap browser.

The text inputting unit 240 receives an external input of text for controlling the remote UI server device 300 by using a UI resource. The text inputting unit 240 receives the external input of text via a web page or an application with a text inputting interface. The application is either received from the remote UI server device 300 or exists in the remote UI client device 200.

The text transmitting unit 250 transmits text externally input using a UI resource to the remote UI server device 300. The text transmitting unit 250 transmits text in the unit of a consonant and a vowel, in the unit of a character, or in the unit of a sentence. The text transmitting unit 250 may use either the same session as a session for obtaining a UI resource or an asynchronous session independent from the session for obtaining the UI resource. An asynchronous session may be embodied by using, for example, asynchronous JavaScript and XML (AJAX). However, it will be apparent that an asynchronous session may be embodied by using any of various other methods. AJAX refers to a web developing technique for authoring a communicative web application and is capable of exchanging and manipulating data asynchronously with a web server. Detailed descriptions of AJAX are omitted here.

FIG. 3 is a block diagram of the remote UI server device 300 according to an exemplary embodiment.

The remote UI server device 300 includes a UI selecting unit 310, an event handling unit 320, a UI resource transmitting unit 330, a text receiving unit 340, an outputting unit 350, a control unit 360, and a capability matching unit 370.

The UI selecting unit 310 receives an external input corresponding to selection of a UI resource for requesting an input of text for controlling the remote UI server device 300.

When a UI resource selected by the UI selecting unit 310 needs a text input, the event handling unit 320 transmits an event message including a URL for accessing the UI resource to the remote UI client device 200.

In response to a request by the remote UI client device 200, the UI resource transmitting unit 330 transmits a UI resource to the remote UI client device 200. Protocols via which the UI resource transmitting unit 330 may transmit a UI resource include, for example, XRT, RFP, or HTTP. However, it will be apparent that other protocols may also be used.

The capability matching unit 370 transmits capability information with respect to a UI resource to the remote UI client device 200. Capability information includes, for example, resolution information and codec information with respect to a UI resource. The remote UI client device 200 may obtain a UI resource that can be processed by the remote UI client device 200 with reference to capability information transmitted by the capability matching unit 370.

Meanwhile, if a device (e.g., a UPnP control point device) acting as a negotiator between the remote UI server device 300 and the remote UI client device 200 exists, the capability matching unit 370 transmits capability information with respect to a UI resource to the negotiating device. In this case, the capability matching unit 370 obtains capability information negotiated between the remote UI server device 300 and the remote UI client device 200 from the negotiating device. The UI resource transmitting unit 330 may transmit a UI resource that can be processed by the remote UI client device 200 with reference to the negotiated capability information obtained by the capability matching unit 370.

Meanwhile, an event message may be provided according to any of the various home network standards, including, for example, the UPnP RemoteUI or CEA 2014 standards.

The text receiving unit 340 receives text from the remote UI client device 200. The text receiving unit 340 receives text in the unit of a consonant and a vowel, in the unit of a character, or in the unit of a sentence. The text receiving unit 340 may use either the same session as a session for transmitting a UI resource or an asynchronous session independent from the session for transmitting the UI resource. An asynchronous session may be embodied, for example, by using AJAX. However, it will be apparent that an asynchronous session may be embodied by using other methods.

The outputting unit 350 outputs text. The control unit 360 performs a control function related to the text.

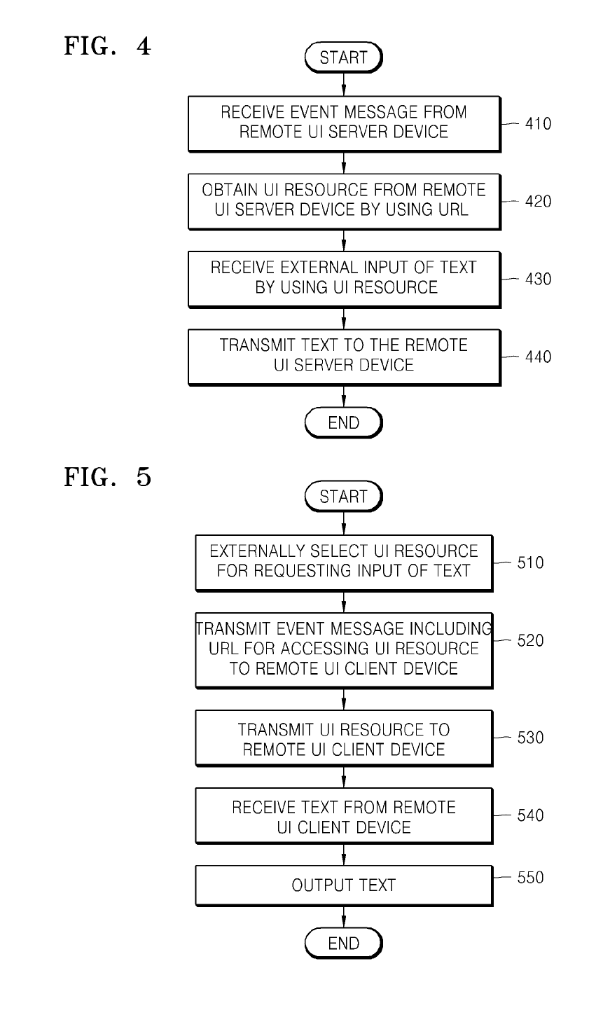

FIG. 4 is a flowchart of providing a remote UI service by a remote UI client device according to an exemplary embodiment.

In operation 410, if a user input, such as a text input, is needed while a user is browsing menus in a remote UI server device 300, the remote UI client device 200 receives an event message including a URL for accessing a UI resource corresponding to a current state.

A UI resource provides a user interface for inputting text, for example, and includes a web page or bitmaps of an application. A web page includes either a text inputting module within itself or a module for activating a text inputting application existing within the remote UI client device 200. For example, when the remote UI client device 200 is an HHP, a web page may include a module for activating an IME application existing within the HHP.

A module for activating a text inputting application may be provided in such a way that, when a user locates a UI focus at a location within a web page, the text inputting application is activated. The location within the web page may be predetermined. Alternatively, the module for activating a text inputting application may be provided according to any of various other methods.

In operation 420, the remote UI client device 200 obtains the UI resource corresponding to the current state from the remote UI server device 300 by using the URL included in the event message received.

In operation 430, the remote UI client device 200 receives an external input of text for controlling the remote UI server device 300 by using the UI resource corresponding to the current state. The remote UI client device 200 receives the external input of text via a web page or an application with a text inputting interface. The application is either received from the remote UI server device 300 or exists in the remote UI client device 200.

In operation 440, the remote UI client device 200 transmits text to the remote UI server device 300. The remote UI client device 200 transmits text in the unit of a consonant and a vowel, in the unit of a character, or in the unit of a sentence. The remote UI client device 200 may use either the same session as a session for obtaining a UI resource or an asynchronous session independent from the session for obtaining the UI resource. An asynchronous session may be provided by using AJAX. However, it will be apparent that an asynchronous session may be provided by using other methods.

FIG. 5 is a flowchart of providing a remote UI service by a remote UI server device according to an exemplary embodiment.

In operation 510, the remote UI server device 300 receives an external input corresponding to selection of a UI resource for requesting an input of text for controlling the remote UI server device 300.

In operation 520, when the UI resource selected in the operation 510 needs an input of text, the remote UI server device 300 transmits an event message including a URL for accessing the UI resource to the remote UI client device 200.

In operation 530, in response to a request by the remote UI client device 200, the remote UI server device 300 transmits the UI resource to the remote UI client device 200.

In operation 540, the remote UI server device 300 receives text from the remote UI client device 200.

In operation 550, the remote UI server device 300 outputs the text.

While has been particularly shown and described with reference to exemplary embodiments thereof, it will be understood by those of ordinary skill in the art that various changes in form and details may be made therein without departing from the spirit and scope of as defined by the following claims.

For example, as shown in FIGS. 2 and 3, each of the remote UI client device 200 and the remote UI server device 300 according to exemplary embodiments may include a bus coupled to each of the components, at least one processor coupled to the bus, and a memory coupled to the bus to store an instruction, a received message, or a generated message and coupled to at least one processor to perform instructions as described above.

The invention can also be embodied as computer readable codes on a computer readable medium. The computer readable medium may include a computer readable recording medium or a computer readable storage medium. The computer readable storage medium is any data storage device that can store data which can be thereafter read by a computer system. Examples of the computer readable storage medium include read-only memory (ROM), random-access memory (RAM), CD-ROMs, magnetic tapes, floppy disks, optical data storage devices, etc. The computer readable storage medium can also be distributed over network coupled computer systems so that the computer readable code is stored and executed in a distributed fashion. The computer readable recording medium may include recording in a transitory signal or transmission via a carrier signal.

What is claimed is:

1. A method of providing a remote user interface (UI) service to a remote UI client device, the method comprising:
receiving an event message including a uniform resource locator (URL) for accessing a UI resource from a remote UI server device;
obtaining the UI resource from the remote UI server device by using the URL;
receiving text input for controlling the remote UI server device by using the UI resource; and
transmitting the text input to the remote UI server device.

2. The method of claim 1, wherein the UI resource comprises a web page or bitmaps of an application, and provides a UI for the text input.

3. The method of claim 2, wherein the web page comprises either a text inputting module within the web page or a module for activating a text inputting application existing within the remote UI client device.

4. The method of claim 2, further comprising outputting the UI resource.

5. The method of claim 4, wherein the outputting of the UI resource comprises outputting the web page by using a web browser or outputting the bitmaps of the UI application by using a bitmap browser.

6. The method of claim 1, further comprising obtaining capability information with respect to the UI resource from the remote UI server device,
wherein the capability information comprises resolution information and codec information with respect to the UI resource.

7. The method of claim 6, further comprising:
transmitting capability information with respect to the UI resource that can be processed by the remote UI client device to a negotiating device; and
receiving negotiated capability information negotiated between the remote UI server device and the remote UI client device from the negotiating device.

8. The method of claim 1, wherein, during the transmitting of the text input to the remote UI server device, the text is transmitted in an unit of a consonant and a vowel, in an unit of a character, or in an unit of a sentence, and
the text is transmitted by using either a same session as a session for obtaining the UI resource or an asynchronous session independent from the session for obtaining the UI resource.

9. The method of claim 1, wherein the event message is provided according to an universal plug and play (UPnP) RemoteUI standard or a consumer electronics association (CEA) 2014 standard.

10. A method of providing a remote user interface (UI) service to a remote UI server device, the method comprising:
receiving a selection of a UI resource for requesting text input for controlling the remote UI server device;
transmitting an event message comprising a uniform resource locator (URL) for accessing the UI resource to a remote UI client device;
transmitting the UI resource to the remote UI client device in response to a request by the remote UI client device;
receiving the text input from the remote UI client device; and
outputting the text.

11. The method of claim 1, further comprising performing a control function related to the text.

12. The method of claim 10, wherein the UI resource comprises a web page or bitmaps of an application, and provides a UI for the text input.

13. The method of claim 12, wherein the web page comprises either a text inputting module within the web page or a module for activating a text inputting application existing within the remote UI client device.

14. The method of claim 10, further comprising transmitting capability information with respect to the UI resource to the remote UI client device,
wherein the capability information comprises resolution information and codec information with respect to the UI resource.

15. The method of claim 14, further comprising:
transmitting the capability information with respect to the UI resource to a negotiating device; and
receiving negotiated capability information negotiated between the remote UI server device and the remote UI client device from the negotiating device.

16. The method of claim 10, wherein, during the receiving of the text input, the text is received in an unit of a consonant and a vowel, in an unit of a character, or in an unit of a sentence, and
the text is received by using either a same session as a session for transmitting the UI resource or an asynchronous session independent from the session for transmitting the UI resource.

17. The method of claim 10, wherein the event message is provided according to a universal plug-n-play (UPnP) RemoteUI standard or a consumer electronics association (CEA) 2014 standard.

18. A remote user interface (UI) client device comprising:
an event handling unit that receives an event message including a URL for accessing a UI resource from a remote UI server device;
a UI resource obtaining unit that obtains the UI resource from the remote UI server device by using the URL;
a text inputting unit that receives an input of text for controlling the remote UI server device by using the UI resource; and
a text transmitting unit that transmits the input text to the remote UI server device.

19. The remote UI client device of claim 18, wherein the UI resource comprises a web page or bitmaps of an application, and provides a user UI for the input of the text.

20. The remote UI client device of claim 19, wherein the web page comprises either a text inputting module within the web page or a module for activating a text inputting application existing within the remote UI client device.

21. The remote UI client device of claim 20, further comprising an outputting unit that outputs the UI resource.

22. The remote UI client device of claim 21, wherein the outputting unit either outputs a web page by using a web browser or outputs the bitmaps of the UI application by using a bitmap browser.

23. The remote UI client device of claim 18, further comprising a capability matching unit that obtains capability information with respect to the UI resource from the remote UI server device,
wherein the capability information comprises resolution information and codec information with respect to the UI resource.

24. The remote UI client device of claim 23, wherein the capability matching unit transmits capability information with respect to the UI resource that can be processed by the remote UI client device to a negotiating device and obtains the capability information negotiated between the remote UI server device and the remote UI client device from the negotiating device.

25. The remote UI client device of claim 18, wherein the text transmitting unit transmits the text in an unit of a consonant and a vowel, in an unit of a character, or in an unit of a sentence, and
the text is transmitted by using either a same session as a session for obtaining the UI resource or an asynchronous session independent from the session for obtaining the UI resource.

26. The remote UI client device of claim 18, wherein the event message is provided according to universal plug and play (UPnP) RemoteUI standard or a consumer electronics association (CEA) 2014 standard.

27. A remote user interface (UI) server device comprising:
a UI selecting unit that receives a selection of a UI resource for requesting an input of text for controlling the remote UI server device;
an event handling unit that transmits an event message including a uniform resource locator (URL) for accessing the UI resource to a remote UI client device;
a UI resource transmitting unit that transmits the UI resource to the remote UI client device in response to a request by the remote UI client device;
a text receiving unit that receives the text from the remote UI client device; and
an outputting unit that outputs the text.

28. The remote UI server device of claim 27, further comprising a control unit that performs a control function related to the text.

29. The remote UI server device of claim 27, wherein the UI resource comprises a web page or bitmaps of an application, and provides a UI for the input of the text.

30. The remote UI server device of claim 29, wherein the web page comprises either a text inputting module provided within the web page or a module for activating a text inputting application existing within the remote UI client device.

31. The remote UI server device of claim 27, further comprising a capability matching unit that transmits capability information with respect to the UI resource to the remote UI client device,
wherein the capability information comprises resolution information and codec information with respect to the UI resource.

32. The remote UI server device of claim 31, wherein the capability matching unit transmits capability information with respect to the UI resource to a negotiating device and obtains the capability information negotiated between the remote UI server device and the remote UI client device from the negotiating device.

33. The remote UI server device of claim 27, wherein the text receiving unit receives the text in an unit of a consonant and a vowel, in an unit of a character, or in an unit of a sentence, and
the text is received by using either a same session as a session for transmitting the UI resource or an asynchronous session independent from the session for transmitting the UI resource.

34. The remote UI server device of claim 27, wherein the event message is provided according to an universal plug-n-play (UPnP) RemoteUI standard or a consumer electronics association (CEA) 2014 standard.

35. A computer readable recording medium having recorded thereon a computer program for executing the method of claim 1.

36. A computer readable recording medium having recorded thereon a computer program for executing the method of claim 10.

37. A method of providing a remote user interface (UI) service performed on a remote UI client device, the method comprising:
receiving an event message including a uniform resource locator (URL) for accessing a UI resource;
obtaining the UI resource using the URL;
receiving text input using the UI resource; and
transmitting the text.

38. The method of claim 37, further comprising obtaining capability information with respect to the UI resource,
wherein the capability information comprises resolution information and codec information with respect to the UI resource.

39. The method of claim 38, further comprising:
transmitting capability information with respect to the UI resource that can be processed; and
receiving negotiated capability information.

40. A method of providing a remote user interface (UI) service performed on a remote UI server device, the method comprising:
receiving a selection of a UI resource that uses text input for control;
transmitting an event message comprising a uniform resource locator (URL) for accessing the UI resource;
transmitting the UI resource in response to a request that is received;
receiving text; and
outputting the text.

41. The method of claim 40, further comprising transmitting capability information with respect to the UI resource,
wherein the capability information comprises resolution information and codec information with respect to the UI resource.

42. The method of claim 41, further comprising:
transmitting the capability information with respect to the UI resource; and
receiving negotiated capability information.
